(19) United States
(12) Patent Application Publication
(10) Pub. No.: US 2017/0178845 A1
(43) Pub. Date: Jun. 22, 2017

(54) GAS INSULATED CIRCUIT BREAKER

(71) Applicant: Hyundai Heavy Industries Co., Ltd., Ulsan (KR)

(72) Inventor: Hyung-Choon Kim, Ulsan (KR)

(73) Assignee: Hyundai Heavy Industries Co., Ltd., Ulsan (KR)

(21) Appl. No.: 15/327,446

(22) PCT Filed: Jun. 15, 2015
(86) PCT No.: PCT/KR2015/005998

§ 371 Date: Jan. 19, 2017

(30) Foreign Application Priority Data
Sep. 25, 2014 (KR) 10-2014-0128610

(51) Int. Cl. H01H 33/88; H01H 33/86

(52) U.S. Cl. CPC H01H 33/88; H01H 33/86

(57) ABSTRACT

Disclosed is a gas insulated circuit breaker having enhanced insulation properties. A gas insulated circuit breaker comprises: a fixed cylinder unit of which a movable contact point has an internal space; a movable piston unit which is slidably inserted into the inner space of the fixed cylinder unit; a fixing unit provided in a rear of the fixed cylinder unit in the internal space of the fixed cylinder unit; a puffer chamber which is formed by having the movable piston unit, fixed cylinder unit and fixing unit, surrounding the puffer chamber; and a gas inlet unit which forms a path, between the puffer chamber and the outer part of the fixed cylinder unit, through which a gas flows.

### TECHNICAL FIELD

The present disclosure relates to a gas insulated circuit breaker, and in more detail, to a gas insulated circuit breaker having enhanced insulation properties.

### BACKGROUND ART

In general, a gas insulated circuit breaker is a device for switching a load or breaking a current in a case in which an accident such as a short-circuit, grounding, or the like occurs, in a transmission and transformer system or an electric circuit.

As described above, a gas breaker, a device for breaking a fault current, uses gas for extinguishing an arc. Here, an arc generated between two contact points is extinguished by gas.

The gas breaker described above may be classified as a puffer extinction type gas breaker, a rotary arc extinction type gas breaker, a thermal expansion extinction type gas breaker, a hybrid extinction type gas breaker, or the like, according to a method by which an arc is extinguished. In a gas breaker according to the related art, sulfur hexafluoride (SF₆) is used as an extinction gas.

A puffer extinction type gas breaker utilizes a method in which an arc is extinguished when an extinction gas is compressed in a compression chamber (a puffer chamber) inside a breaking unit to be blown between poles using external driving force, when a breaker performs a breaking operation of a fault current.

In addition, the thermal expansion extinction type gas breaker utilizes a method in which the heat of an arc, generated when a breaking operation of a fault current is performed, is accumulated in a thermal expansion chamber and pressure, increased by the accumulated heat, blows between poles.

Meanwhile, a gas breaker in which the puffer extinction type gas breaker and the thermal expansion extinction type gas breaker are combined with each other is known as a hybrid extinction type gas breaker.

Such a hybrid extinction type gas breaker uses heat generated by an arc when a breaking operation of a fault current is performed, as energy for increasing pressure in a thermal expansion chamber. When a current zero is detected, gas at a high pressure in the thermal expansion chamber is injected between poles (an extinction part) again to maintain insulation between the poles, thereby breaking between the poles.

In a hybrid extinction type gas breaker, heated gas at a high temperature may be generated by an arc generated between poles when a breaking operation is performed.

In this case, the generated heated gas may flow into a thermal expansion chamber, or may flow inwardly of a movable arc contact point to flow along an internal space of an operating rod connected to the movable arc contact point to be discharged to a space formed in a rear end of a movable fixed conductor.

However, a gas breaker according to the related art is formed to allow an insulation gas stored in a space formed in the rear end of the movable fixed conductor to flow into a puffer chamber, during a making operation is performed. Here, the insulation gas stored in the space formed in the rear end of the movable fixed conductor is heated gas at a high temperature generated when a primary breaking operation is performed, and remaining at a high temperature, since cooling thereof is not performed.

Therefore, the insulation gas at a high temperature is stored in the puffer chamber. When a secondary breaking operation is performed, the insulation gas, at a high temperature, is injected between poles. Due to a high temperature, there may be a disadvantage in which insulation properties of a gas breaker are reduced.

### DISCLOSURE

### Technical Problem

An aspect of the present disclosure may provide a gas insulated circuit breaker in which cold gas is used for arc extinction.

### Technical Solution

According to an aspect of the present disclosure, a gas insulated circuit breaker has a fixed contact point, a fixed arc contact point, a movable contact point, and a movable arc contact point, and is formed such that heated gas generated between poles flows into the movable arc contact point and is discharged toward an inner side of the movable contact point. The gas insulated circuit breaker includes: a fixed cylinder unit of which the movable contact point has an internal space; a movable piston unit slidably inserted into the internal space of the fixed cylinder unit; a fixing unit provided in a rear of the fixed cylinder unit in the internal space of the fixed cylinder unit; a puffer chamber formed by the movable piston unit, the fixed cylinder unit, and the fixing unit, surrounding the puffer chamber; and a gas inlet unit forming a path, between the outer part of the fixed cylinder unit and the puffer chamber, through which a gas flows.

The gas inlet unit may have a flow path formed in the fixed cylinder unit and the fixing unit to allow one end to be connected to the puffer chamber and the other end to be connected to the outer part of the fixed cylinder unit.

The fixing unit may have a plate form or a block form, dividing the internal space of the fixed cylinder unit to be sealed, and the gas inlet unit may be formed as a hole passing through a body of the fixing unit to be formed.

An inlet valve provided in the gas inlet unit, and opening the gas inlet unit when gas flows into the puffer chamber, may be further included therein.

The inlet valve may be provided to stop gas from being discharged in a direction of the gas inlet unit from the puffer chamber.

A gas discharge unit forming a path in which gas contained in the puffer chamber is discharged externally may be further included therein.

The gas discharge unit may have a flow path provided in the fixing unit to allow one end to be connected to the puffer chamber and the other end to be connected to the outer part of the puffer chamber.

A discharge valve provided in the gas discharge unit, and opening the gas discharge unit when gas in the puffer chamber flows eternally may be further included therein.

The discharge valve may be provided to stop gas from flowing in a direction of the puffer chamber through the gas discharge unit.

The internal space of the fixed cylinder unit may be provided with a gas discharge space in the rear of the fixing unit, and the gas discharge unit may be provided to allow one end to be connected to the puffer chamber and the other end to be connected to the gas discharge space.

### Advantageous Effects

According to an exemplary embodiment in the present disclosure, a gas insulated circuit breaker is provided to prevent gas heated to a high temperature from flowing into a puffer chamber and a cold gas located outside of a movable contact point to flow in. When breaking a circuit, the cold gas is used for arc extinction, thereby having enhanced insulation properties.

### DESCRIPTION OF DRAWINGS

FIG. 1 is a side cross-sectional view of a gas insulated circuit breaker according to an exemplary embodiment.

FIG. 2 is a side cross-sectional view of a fixing unit included in the gas insulated circuit breaker illustrated in FIG. 1.

FIG. 3 is a side cross-sectional view illustrating a flow of insulation gas when the gas insulated circuit breaker illustrated in FIG. 1 performs a breaking operation.

FIG. 4 is a side cross-sectional view illustrating a flow of insulation gas when the gas insulated circuit breaker illustrated in FIG. 1 performs a making operation.

### BEST MODE FOR INVENTION

The terms used herein are used to describe particular embodiments, and are not intended to limit the present disclosure. In addition, in this application, singular forms include plural forms unless the context clearly indicates otherwise.

Hereinafter, exemplary embodiments of the present disclosure will be described in detail with reference to the accompanying drawings.

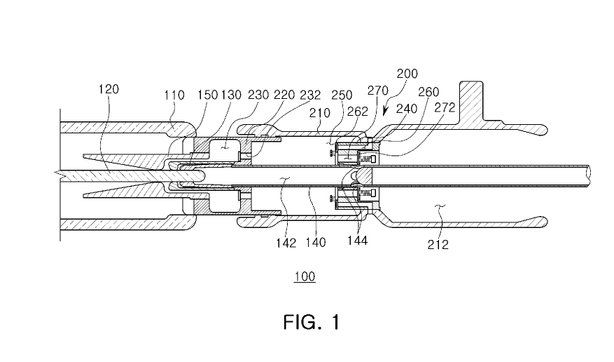

With reference to FIGS. 1 to 4, a gas insulated circuit breaker according to an exemplary embodiment will be described.

As illustrated in FIGS. 1 to 4, a gas insulated circuit breaker 100 according to an exemplary embodiment may include a fixed contact point 110, a fixed arc contact point 120, a movable arc contact point 130, an operating rod 140, a movable contact point 200, and a nozzle 150.

The fixed contact point 110 is a conductor having an overall cylindrical shape, and is provided to allow the movable contact point 200 to be described later to be inserted into a front end. The fixed contact point 110 may form a current carrying path of a power system along with the movable contact point 200 as the movable contact point 200 to be described later is inserted into an inner side.

The fixed arc contact point 120, as a conductor provided in an internal space of the fixed contact point 110, may form a path in which an arc, generated in a contact point in a making and breaking operation of a breaker, moves.

In an exemplary embodiment, the fixed arc contact point 120 may be formed of a conductor in the form of a bar placed side by side in a longitudinal direction of the fixed contact point 110 in a center of the internal space of the fixed contact point 110.

The fixed arc contact point 120 may be inserted into and connected to the front end of the movable arc contact point 130 to be described later when a breaker performs a making operation.

The movable arc contact point 130, provided in an inner side of the movable contact point 200 to be described later, is provided to be connected to the fixed arc contact point 120 in a making operation and to be separated from the fixed arc contact point 120 in a breaking operation, thereby forming a path in which an arc, generated in a contact point in a making and breaking operation of a breaker, moves.

In an exemplary embodiment, the movable arc contact point 130 may be combined with a front end of the movable piston unit 220 or may be integrally formed with the movable piston unit 220, to be in concordance with behavior of a movable piston unit 220 of the movable contact point 200 to be described later.

In an exemplary embodiment, the movable arc contact point 130 may be formed of a cylindrical conductor to allow the fixed arc contact point 120 to be inserted into and combined with an inner side, or may be formed of a plurality of connection tips forming a tulip shape.

Meanwhile, when a breaker performs a breaking operation, a portion of heated gas, generated due to an arc generated between the movable arc contact point 130 and the fixed arc contact point 120, may flow toward the inner side of the movable arc contact point 130.

The operating rod 140 is connected to a rear end of the movable piston unit 220 to be described later, and may allow the movable piston unit 220 to move forwards and backwards.

The operating rod 140 is connected to an external operating device (not shown) to transmit power of an operating device to the movable piston unit 220 to be described later.

In addition, the operating rod 140 is formed of an insulator to insulate between the movable piston unit 220 and an external operating device.

In an exemplary embodiment, the operating rod 140 may be formed of a bar-shaped member disposed in an axial direction in a center inside the movable contact point 200, and a front end thereof may be connected to the movable arc contact point 130.

In this case, the operating rod 140 may be formed of a pipe type shaft in which a gas discharge flow path 142 is formed, as illustrated in FIG. 1.

In addition, in an exemplary embodiment, the operating rod 140 may include an exhaust port 144 opened in a direction of a gas discharge space 212 formed in a fixed cylinder unit 210 to be described later.

When a breaker performs a breaking operation, after heated gas, generated between poles, flows into the gas discharge flow path 142 of the operating rod 140 through an inner side of the movable arc contact point 130, the heated gas is discharged to the gas discharge space 212 of the fixed cylinder unit 210 to be described later, through the exhaust port 144.

The movable contact point 200 may include the fixed cylinder unit 210, the movable piston unit 220, a fixing unit 240, a puffer chamber 250, a gas inlet unit 260, and a gas discharge unit 270.

Here, the fixed cylinder unit 210 may be formed of a conductor whose one side is opened and having an internal space.

In an exemplary embodiment, the fixed cylinder unit 210 may be formed of a cylindrical conductor in which a side opposing the fixed contact point 110 is opened, as illustrated in FIG. 1.

A position of the fixed cylinder unit 210 is fixed in a breaking and making operation of a breaker, and the fixed cylinder unit may support movement of the movable piston unit 220, to be described later, sliding in an internal space.

In an exemplary embodiment, in an internal space of the fixed cylinder unit 210, as illustrated in FIG. 1, the gas discharge space 212 may be formed in a rear of the fixing unit 240 to be described later.

When a breaker performs a breaking operation, heated gas generated in a front end of the movable arc contact point 130 flows through the gas discharge flow path 142 of the operating rod 140 to be accumulated in the gas discharge space 212.

In addition, the movable piston unit 220 may be inserted into an internal space of the fixed cylinder unit 210 to be slidably formed.

In an exemplary embodiment, the movable piston unit 220 may include a thermal expansion chamber 230 inside.

In addition, the movable piston unit 220 may include the movable arc contact point 130 protruding toward a front end, and may include the nozzle 150 to be described later in the front end.

The movable piston unit 220 is connected to the operating rod 140 to reciprocate in a longitudinal direction of the fixed cylinder unit 210 by the operating rod 140.

In an exemplary embodiment, in a rear end of the movable piston unit 220, to allow gas stored in the puffer chamber 250 to be described later to flow into the thermal expansion chamber 230, a connection flow path 232 connected between the puffer chamber 250 and the thermal expansion chamber 230.

In addition, the fixing unit 240 is a member in a plate form or a block form provided to divide an internal space of the fixed cylinder unit 210 to be sealed.

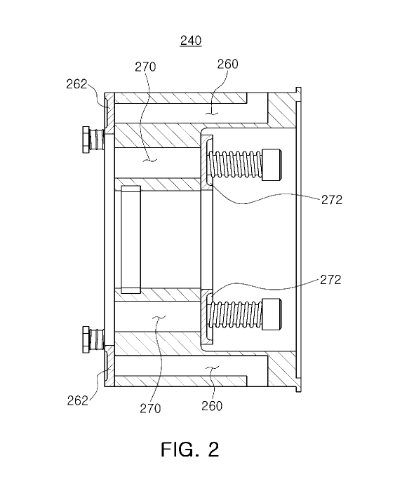

In an exemplary embodiment, as illustrated in FIG. 2, the fixing unit 240 may be formed of a block-shaped member combined with the internal space of the fixed cylinder unit 210, but is not limited thereto. The fixing unit may be integrally formed with the fixed cylinder unit 210.

In addition, as illustrated in FIG. 1, the puffer chamber 250 may be a space formed by having the movable piston unit 220, the fixed cylinder unit 210, and the fixing unit 240, surrounding the puffer chamber.

The puffer chamber 250 may have a volume changed due to movement of the movable piston unit 220.

In addition, the gas inlet unit 260 may form a path, between an outer part of the fixed cylinder unit 210 and the puffer chamber 250, through which gas flows.

In an exemplary embodiment, as illustrated in FIGS. 1 and 2, the gas inlet unit 260 may be formed as a hole passing through a body of the fixing unit 240 to be formed.

In detail, the gas inlet unit 260 may be provided to allow one end to be connected to the puffer chamber 250 and the other end to be connected to an outer part of the fixed cylinder unit 210.

The gas inlet unit 260 may form a flow path for allowing gas to be distributed between an outer part of the fixed cylinder unit 210 and the puffer chamber 250.

In an exemplary embodiment, as illustrated in FIG. 2, the gas inlet unit 260 may be formed as a hole extended from a front end of the fixing unit 240 to a rear thereof and having a form in which a rear end is bent externally of the fixed cylinder unit 210, but is not limited thereto. The gas inlet unit may be formed as a hole formed at an incline externally of the fixed cylinder unit 210 from a front end of the fixing unit 240.

Here, in the fixed cylinder unit 210, a hole communicating with an outlet of the gas inlet unit 260 formed in the fixing unit 240 may be formed therein. Thus, gas discharged from the gas inlet unit 260 may be discharged externally through the hole formed in the fixed cylinder unit 210.

However, a structure of the fixed cylinder unit 210 is not limited thereto. The fixed cylinder unit 210 may have a cylindrical shape surrounding an outer side of the fixing unit 240, while a rear end thereof may be provided to be disposed in front of an outlet of the gas inlet unit 260 to expose the gas inlet unit 260 externally.

In addition, in an exemplary embodiment, the fixing unit 240 may be provided with an inlet valve 262.

The inlet valve 262 is provided in one end of the gas inlet unit 260, and may open the gas inlet unit 260 when gas flows into the puffer chamber 250 from an outside of the fixed cylinder unit 210.

In an exemplary embodiment, the inlet valve 262 may be provided as a check valve for closing the gas inlet unit 260 in a direction in which gas in the puffer chamber 250 flows externally, and for opening the gas inlet unit 260 in a direction in which an external gas flows into the puffer chamber 250.

Meanwhile, the gas discharge unit 270 may form a path in which gas contained in the puffer chamber 250 is discharged externally.

In an exemplary embodiment, as illustrated in FIG. 2, the gas discharge unit 270 may be formed as a hole passing through a body of the fixing unit 240 in a longitudinal direction to be formed.

In detail, the gas discharge unit 270 may be provided to allow one end to be connected to the puffer chamber 250 and the other end to be connected to the gas discharge space 212.

The gas discharge unit 270 may form a flow path for allowing gas to be distributed between the puffer chamber 250 and the gas discharge space 212.

In addition, in an exemplary embodiment, the gas discharge unit 270 may be provided with a discharge valve 272.

The discharge valve 272 may be provided as a check valve, provided in the other end of the gas discharge unit 270, for opening the gas discharge unit 270 in a direction in which gas in the puffer chamber 250 flows into the gas discharge space 212 and for closing the gas discharge unit 270 in a direction in which external gas flows into the puffer chamber 250.

The nozzle 150 is provided in the front end of the movable piston unit 220, and may be provided to inject gas contained in the thermal expansion chamber 230 into a gap (a part in which an arc is generated) between the movable arc contact point 130 and the fixed arc contact point 120.

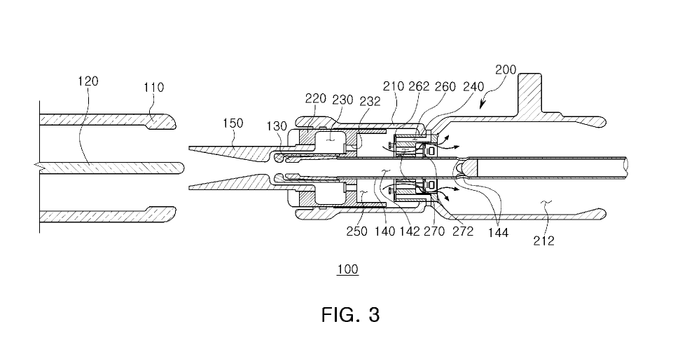

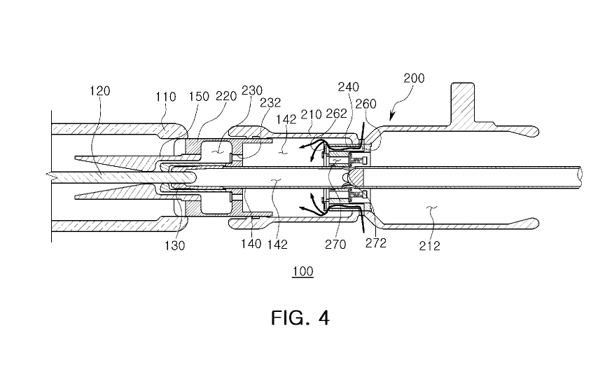

Hereinafter, with reference to FIGS. 3 and 4, breaking and making operations of the gas insulated circuit breaker 100 according to an exemplary embodiment will be described.

As illustrated in FIG. 3, when a primary breaking operation is performed, the movable piston unit 220 is moved backwards from the fixed contact point 110 by the operating rod 140.

In this case, after heated gas generated between the fixed arc contact point 120 and the movable arc contact point 130 flows through the gas discharge flow path 142 of the operating rod 140, the heated gas is discharged to the gas discharge space 212 through the exhaust port 144.

In addition, due to movement backward of the movable piston unit 220, a volume of the puffer chamber 250 is reduced. Thus, gas stored in the puffer chamber 250 is discharged to the gas discharge space 212 through the gas discharge unit 270 of the fixing unit 240.

Meanwhile, as illustrated in FIG. 4, when a making operation is performed, the movable piston unit 220 is moved forwards in a direction of the fixed contact point 110 by the operating rod 140.

In this case, a volume of the puffer chamber 250 is increased and the inlet valve 262 is opened. Thus, cold gas located outside the fixed cylinder unit 210 flows into the puffer chamber 250 through the gas inlet unit 260.

Thereafter, when a secondary breaking operation is performed, the cold gas stored in the puffer chamber 250 is injected between poles to be used for arc extinction.

As described above, the gas insulated circuit breaker 100 according to an exemplary embodiment has the advantage of having enhanced insulation properties, since the gas insulated circuit breaker is provided to allow heated gas at a high temperature not to flow into the puffer chamber 250 and cold gas located outside the movable contact point 200 to flow in, so as to use the cold gas for arc extinction when a secondary breaking operation is performed.

While exemplary embodiments with respect to a cutting device and a cutting method have been shown and described above, it will be apparent to those skilled in the art that modifications and variations could be made without departing from the scope of the present invention as defined by the appended claims.

1. A gas insulated circuit breaker, having a fixed contact point, a fixed arc contact point, a movable contact point, and a movable arc contact point, and
formed such that heated gas generated between poles flows into the movable arc contact point and is discharged toward an inner side of the movable contact point,
the gas insulated circuit breaker comprising:
a fixed cylinder unit of which the movable contact point has an internal space;
a movable piston unit slidably inserted into the internal space of the fixed cylinder unit;
a fixing unit provided in a rear of the fixed cylinder unit in the internal space of the fixed cylinder unit;
a puffer chamber formed by the movable piston unit, the fixed cylinder unit, and the fixing unit, surrounding the puffer chamber;
and a gas inlet unit forming a path, between the outer part of the fixed cylinder unit and the puffer chamber, through which gas flows.

2. The gas insulated circuit breaker of claim 1, wherein the gas inlet unit has a flow path formed in the fixed cylinder unit and the fixing unit to allow one end to be connected to the puffer chamber and the other end to be connected to the outer part of the fixed cylinder unit.

3. The gas insulated circuit breaker of claim 2, wherein the fixing unit has a plate form or a block form, dividing the internal space of the fixed cylinder unit to be sealed, and
the gas inlet unit is formed as a hole passing through a body of the fixing unit to be formed.

4. The gas insulated circuit breaker of claim 2, further comprising an inlet valve provided in the gas inlet unit, and opening the gas inlet unit when gas flows into the puffer chamber.

5. The gas insulated circuit breaker of claim 4, wherein the inlet valve is provided to stop gas from being discharged in a direction of the gas inlet unit from the puffer chamber.

6. The gas insulated circuit breaker of claim 1, further comprising a gas discharge unit forming a path in which gas contained in the puffer chamber is discharged externally.

7. The gas insulated circuit breaker of claim 6, wherein the gas discharge unit has a flow path provided in the fixing unit to allow one end to be connected to the puffer chamber and the other end to be connected to the outer part of the puffer chamber.

8. The gas insulated circuit breaker of claim 6, further comprising a discharge valve provided in the gas discharge unit, and opening the gas discharge unit when gas in the puffer chamber flows externally.

9. The gas insulated circuit breaker of claim 6, wherein the discharge valve is provided to stop gas from flowing in a direction of the puffer chamber through the gas discharge unit.

10. The gas insulated circuit breaker of claim 6, wherein the internal space of the fixed cylinder unit is provided with a gas discharge space in the rear of the fixing unit, and
the gas discharge unit is provided to allow one end to be connected to the puffer chamber and the other end to be connected to the gas discharge space.
